(19) United States
(12) Patent Application Publication
(10) Pub. No.: US 2010/0040249 A1
(43) Pub. Date: Feb. 18, 2010

(54) ULTRASONIC AND MULTIMODALITY ASSISTED HEARING

(76) Inventor: Martin L. Lenhardt, Hayes, VA (US)

Correspondence Address: Hershkovitz & Associates, LLC, 2845 Duke Street, Alexandria, VA, 22314, US

(21) Appl. No.: 12/522,158

(22) PCT Filed: Jan. 3, 2008
(86) PCT No.: PCT/US08/50098

§ 371 Date: Jul. 3, 2009

Related U.S. Application Data
(60) Provisional application No. 60/878,111, filed on Jan. 3, 2007.
(60) Provisional application No. 60/878,366, filed on Jan. 4, 2007.

(51) Int. Cl. H04R 25/00

(52) U.S. Cl. 381/316; 381/326; 381/317; 704/233; 381/71.11

(57) ABSTRACT

Speech is modulated and processed to provide a signal that is intelligible in high noise environments. Also, a device (and method of using said device) for improving the perception of acoustic signals comprising non-vocal patterns such as music is presented which utilizes high-frequency carriers in conjunction with signal modulation. Finally, a signal containing acoustic information is presented to a listener using multiple modalities including ultrasonic perception via brain demodulation, air-conduction, and tactile stimulation to provide an enhanced perception of sound.

### CROSS-REFERENCE TO RELATED APPLICATIONS

This application claims the benefit of provisional patent application No. 60/878,111 entitled “ULTRASONIC ASSISTED MUSIC PERCEPTION” filed Jan. 3, 2007, the entirety of which is incorporated by reference. This application also claims the benefit of provisional patent application No. 60/878,366 entitled “SPEECH PERCEPTION IN NOISE DEVICE AND METHOD” filed Jan. 4, 2007, the entirety of which is incorporated by reference.

### BACKGROUND OF THE INVENTION

1. Field of Invention

The present invention relates to a device for performing transformations of a signal using ultrasonic carriers and methods of using said device for improving hearing ability as well as speech, music, or other signal intelligibility and understanding by persons using one or more signal modalities.

2. Description of the Related Art

Conventional air conduction hearing aids only amplify either the entire speech signal or certain portions, or frequency bands, or the speech signal. The most intense part of speech is the fundamental frequency derived from action of the vocal folds. Higher frequencies are derived from vocal tract resonance, but their intensities are lower than those of the fundamental frequency.

The relatively lower intensity, higher frequency speech sounds are generally consonants. Consonants carry most of the information in speech, and are important for normal speech perception. In the cases of sensorineural hearing loss, consonant detection is altered, as is intelligibility. Because conventional aid conduction hearing aids focus on amplifying all or portions of the speech spectrum to regain intelligibility for persons with hearing loss, conventional air conduction hearing aids are ineffective at some degree of hearing loss, depending on the nature of the loss and the individual differences. Alternative approaches have included using frequency bands not compromised by the hearing loss. One approach, disclosed in U.S. Pat. No. 4,982,434 (and hereby incorporated in its entirety by reference) involves frequency-converting the speech to an ultrasonic region (>30,000 Hz), while another approach involves frequency transposition, i.e., focusing the speech into a bass region (<300 Hz). The upper audio range, from about 10,000 Hz to 29,999 Hz, has been neglected.

There is a present need for a device that can utilize sound transformation techniques, including modulation onto ultrasonic carriers, to improve the audio characteristics of a signal. For example, music loss among musicians is common and in some instances may be unrecognized because only tonal frequencies related to music are affected. In most, there is some detectable loss of full hearing ability. When coupled with normal auditory aging effects, composers, mixers, performers, and musicians in general do not have the same hearing capabilities relative to younger age groups of the same persons. Typically, essential sounds and temporal patterns in music are undetected or misinterpreted leading to difficulty in the practice and enjoyment of music. Hearing aids, which are designed specifically for enhancing the understanding of speech and vocal patterns, are ineffective in restoring a sufficient degree of comprehensibility with regards to musical, i.e. non-vocal, patterns.

Speech sound processing by the human brain differs from that of non-vocal, i.e. non-speech, sounds because speech has a defined signal source (vocal folds) and filter (vocal track). In contrast, music is generated by numerous sources, e.g. vibrating strings, percussion instruments, and so on. With hearing loss, musicians have a reduced number of natural filters adapted for increasing the perception and understanding of music, especially in the high frequencies. As such, there is a present need to address the loss of appropriate natural filtering and for a device which will allow a user to hear non-vocal patterns, such as music, with increased comprehensibility and integrity.

An additional need for a device capable of improving audio signal characteristics is presented by background noise. Speech embedded in noise is notoriously unintelligible. One means for increasing the intelligibility of speech is to modulate the amplitude, e.g., the volume or loudness, of the speech to greater than background noise levels. However, in very high noise environments (>100 dB SPL), amplification of speech is ineffective or greatly reduced in effectiveness in increasing recognition and understanding. Further, because the frequency spectrum of human speech generally overlaps in spectrum with most sources of noise, ambient noise filtering is not an expedient or successful alternative in all cases. As such, there is a need for a device and method of using said device for increasing the intelligibility of human speech when significant background noise exists.

It is an object of the present invention to provide a device and method of using said device that accomplishes one or more of the above desired objectives. In addition, additional objects will become apparent after consideration of the following descriptions and claims.

### SUMMARY OF THE INVENTION

The invention is directed to a hearing aid (broadly defined as a device which improves the audio characteristics of a signal for a specific purpose), which generally includes an input device for receiving a signal, a transform device(s) which may comprise filters, amplifiers, and (de)modulators, and an output device which may comprise transducers. One major advantage of the present invention is the capability to provide multimodality assisted hearing, meaning that multiple transducer types are used to present an acoustic signal to a listener via different modalities, e.g. tactile, normal auditory, ultrasonic bone conduction, etc., which results in improved perception of the signal. A key synergy is the use of multimodality presentation in conjunction with the signal processing methods and means described below.

In some embodiments, the invention also comprises a plurality of channels for receiving an input speech signal, one of the channels filtering the speech signal with a first filter centered at a first predetermined audio frequency and having a first predetermined filter bandwidth, another of the channels filtering the speech signal with a second filter centered at a second predetermined audio frequency and having a second filter bandwidth. The hearing aid may also includes an envelope extraction unit for extracting an envelope of an output of each of the channels, and a multi-channel frequency multiplication unit for performing a modulation of each of the envelopes obtained from the output of each of the channels using a carrier that is in an upper audio frequency range. The hearing aid may further include one or more transducer units (preferably at least two different types of transducer units such as an ultrasonic transducer and an air-conduction transducer) for providing vibration and sound in the ear canal or as a vibration to the skin of a user based on the modulated envelopes.

The present invention is also, in one or more embodiments, a device which utilizes a series of independent channels employing digital processing algorithms to clarify the key elements specific to the range of operator impaired hearing. In a highly preferred embodiment, the present invention incorporates upper audio range hearing with other signal recognition modalities including standard air conduction hearing (both unamplified and amplified) and vibratory/tactile signal transduction.

### BRIEF DESCRIPTION OF THE DRAWINGS

The above-mentioned object and advantages of the invention will become more fully apparent from the following detailed description when read in conjunction with the accompanying drawings, with like reference numerals indicating corresponding parts throughout, and wherein:

FIG. 1 is a block diagram of an upper audio hearing aid according to one embodiment of the invention.

### DEFINITIONS

Certain terms of art are used in the specification that are to be accorded their generally accepted meaning within the relevant art; however, in instances where a specific definition is provided, the specific definition shall control. Any ambiguity is to be resolved in a manner that is consistent and least restrictive with the scope of the invention. No unnecessary limitations are to be construed into the terms beyond those that are explicitly defined. The following terms are hereby defined:

CARRIER or CARRIER WAVE: A waveform suitable for modulation by an information-bearing signal; a waveform (usually sinusoidal) that is modulated (modified as by signal multiplication) with an input signal for the purpose of conveying information, for example voice or data, to be transmitted. This carrier wave is usually of much higher frequency than the baseband modulating signal (the signal which contains the information).

SIDEBAND: A sideband is a band of frequencies higher than or lower than the carrier frequency, containing power as a result of the modulation process. The sidebands consist of all the Fourier components of the modulated signal except the carrier. All forms of modulation produce sidebands. Amplitude modulation of a carrier wave normally results in two mirror-image sidebands. The signal components above the carrier frequency constitute the upper sideband (USB) and those below the carrier frequency constitute the lower sideband (LSB). In conventional AM transmission, the carrier and both sidebands are present, sometimes called double sideband amplitude modulation (DSB-AM).

FILTER: An electrical device used to affect certain parts of the spectrum of a sound, generally by causing the attenuation of bands of certain frequencies. In the present invention, a filter may comprise, without limit: high-pass filters (which attenuate low frequencies below the cut-off frequency); low-pass filters (which attenuate high frequencies above the cut-off frequency); band-pass filters (which combine both high-pass and low-pass functions); band-reject filters (which perform the opposite function of the band-pass type); octave, half-octave, third-octave, tenth-octave filters (which pass a controllable amount of the spectrum in each band); shelving filters (which boost or attenuate all frequencies above or below the shelf point); resonant or formant filters (with variable centre frequency and Q). A group of such filters may be interconnected to form a filter bank. In embodiments of the present invention, where more than one filter may be used to properly adjust the characteristics of a signal, a filter may be a single filter, a group of filters, and/or a filter bank.

TEMPORAL FILTRATION: Temporal filtration is a means of removing or selecting temporal information in speech, wherein temporal information subsists of frequency bands containing amplitude fluctuations. For example, envelope fluctuations are understood to exist primarily below 50 Hz; periodicity (voicing) fluctuations occur between approximately 50 and 500 Hertz; and fine structure fluctuations exists above these rates. Temporal filtration may include low pass filtering, also known as smoothing, of a rectified speech signal.

VOCAL FORMANTS: Frequency ranges where the harmonics of vowel sounds are enhanced. It may also be a peak in the harmonic spectrum of a complex sound arising from the resonance of a source. Formants add comprehensibility to speech.

VOCALIC DETECTOR: Means for detecting vowel like sounds.

TIMBRE: The distinguishable characteristics of a tone as mainly determined by the harmonic content of a sound and the dynamic characteristics of the sound. Dynamic characteristics of sound include a sound's vibrato and the attack-decay envelope of a sound.

VOCAL FORMANTS: Frequency ranges where the harmonics of vowel sounds are enhanced. It may also be a peak in the harmonic spectrum of a complex sound arising from the resonance of a source. Formants add comprehensibility to speech.

VIBRATO: Periodic changes in the pitch of a tone; FM like.

TREMOLO: Periodic changes in the amplitude or loudness of tone; AM like.

PITCH: The frequency of a sound wave.

PHONATION: The process of converting the air pressure from the lungs into audible vibrations.

SIGNAL SATURATION: The point at which an amplifier produces no increase in output signal with increasing input signal.

### DETAILED DESCRIPTION OF THE PREFERRED EMBODIMENTS

The embodiments of the invention are directed to a method and a system for upper audio range hearing. An upper audio range hearing device according to the invention converts speech waveform envelope into the upper audio frequencies, >10 kHz, for delivery into the ear canal or to the head or neck of a user and eventually into the inner ear. The device can be single or (preferably) multi-channeled, such that in the multi-channeled configuration, a plurality of signals that are extracted from the original speech waveform are processed to be each converted to upper audio frequency signals. Since the signals are all derived from the same source, they are coherent and can be correlated temporally by the brain into intelligible speech. It is preferred that in all embodiments of the invention in which multiple channels are presented for transduction using different modalities, e.g. tactile, air conduction, bone conduction, and/or ultrasonic conduction, that any calculations or processing of the signals retains the phase of the signal within 20 ms to prevent smearing. For example, a tactile signal and an ultrasonic signal are preferably presented in phase, meaning the frequency modulations match. If the signals are not properly phased, the brain will perceive a smeared signal.

In several embodiments of the invention, the speech signal is converted to the upper audio frequency range by one of amplitude modulation, frequency modulation, or by other means in either analog or digital form. If only a single channel is desired, then it can be selected from the plurality of channels based on frequency content. The upper audio range signals also can be combined with the original speech waveform, either in its natural form or amplified form, to enhance intelligibility in the hearing impaired. The upper audio frequency signal is provided by way of a transducer, such as a piezoelectric device, which vibrates in the upper audio frequency range. The transducer is preferably positioned on the skin of the patient near the ear, but alternatively the transducer can be implanted in the middle or inner ear, such that the upper audio range speech waveform is directly provided to the ossicle, or window or wall of the inner ear. The transducer can alternatively be placed into the ear canal, such that the result is vibratory and sound waves. In this alternative, the output will be sound in the ear canal and vibration in the canal wall to which the transducer touches. Furthermore, a transducer in the inner ear and a transducer on the head or neck may be utilized as another alternative.

In an improvement over other devices, the current invention preferably utilizes multi-modal presentation of signal. For example, presentation of the signal via an ultrasonic transducer (such as by bone-conduction) is combined with normal air-conducted signals and a tactile (vibratory) transducer. The combination of modalities provides better understanding of audio signals then by a single modality and in effect, provides an enriched comprehension and perception then would be expected by the various modalities themselves by mere addition.

According to an embodiment of the invention, a series of filters extract envelope information from a broadband speech or other auditory signal such as music. Each channel carries separate amplitude information based on the passband of the filter in that channel. The signal in each channel is multiplied by an upper audio range (UAR) carrier.

SPEECH PROCESSING: For speech processing, at least one of the filters is preferably set in the vowel frequency range, for example 500 Hz. At least another of the filters is preferably set in the range of high frequency consonants, for example 3.1 kHz. The lowest frequency channel (fundamental vocal frequency) can be presented as low-pass-amplified sound. In one embodiment, the lowest frequency channel is directly provided to the transducer, and in another embodiment, the lowest frequency channel is multiplied by a carrier to the upper audio frequency range. The outputs of the multiple channels are amplified, and delivered via transformers to skin vibrators, or transducers. Outputs of the channels may be mixed or combined prior to output to a single transformer and a single transducer. Alternatively, the outputs of the channels may be individually attenuated (shaped) or presented separately to an array of transducers—one for each channel output. The transducer array may be phase or otherwise manipulated to result in an acceptable sound image for the listener.

The embodiments of the invention have been developed based on the fact that clinical hearing is not generally measured above 10,000 Hz because there is little speech above 6,000 Hz. Thus, while human hearing is present above 10,000 Hz, it is often neglected. There is early hearing loss in this region due to aging, noise or toxicity. Hearing in this range is sometimes monitored to assess insult such as toxicity, but little else. The upper range of normal human hearing for air conducted sound is generally accepted to be about 20,000 Hz, although there have been some reports of human hearing up to about 26,000 Hz. In any event, the threshold of hearing increases rapidly from 10,000 to 26,000 Hz. Either air pressure in the canal or vibration of the head and inner ear can exploit this range.

Upper audio range frequencies, while carrying little direct speech energy, are used in the embodiments of the invention to deliver speech information to the inner ear. If the conventional speech frequencies (100 Hz to 6000 Hz) are shifted such that the fundamental vocal frequency is now in the UAR frequencies (either by some form of amplitude modulation, frequency modulation, or synthetic generation), the ear will be stimulated and speech perception will occur.

The embodiments of the invention transmit the multiplied speech to the skin of the head or neck of the user. The vibrations pass into the inner ear by bone or fluid conduction. While the complete method of transduction at possible inner ear sites is not completely understood at present and need not be known in order to practice the invention, the cochlea and possibly part of the vestibular system is activated. Direct stimulation of nerve VIII that provides speech signals to the brain is less likely, but possible due to the piezoelectric nature of the head anatomy. The UAR signal that is provided to a vibration unit according to the invention is complementary to normal air conduction hearing, and may serve as a reinforcement of speech perception under poor listening conditions, such as in areas where there is high ambient noise.

In a first embodiment, a single channel is used to shift up the speech to the upper auditory range, via amplitude modulation, upper-sideband modulation, double-sideband modulation, frequency modulation, or the like, to thereby create an upper auditory range signal. That signal is amplified and then provided to a transducer, which is disposed in the ear canal or on the head or neck of a user, and which outputs a vibration to the user that is received in the inner ear. That vibration is transferred to the auditory cortex of the brain, where it is interpreted as speech.

In a second embodiment, a plurality of channels is used, such that different frequencies, such as the consonant frequencies that are often overshadowed by the higher-intensity (but lower frequency) vowel frequencies, can be emphasized. By doing so with a plurality of filters and amplifiers, high and low frequency consonant sounds can be processed to have better perceptual salience. Vowel sounds, typically having about 20 dB more energy in the original signal than consonant sounds, may overpower those consonant sounds if only a single channel is used, as in the first embodiment. Thus, the second embodiment provides better speech perception, but at the cost of greater size and power consumption.

In the second embodiment, the channels do not necessarily have to be integrated, because the ear and brain fuse the information into a single percept. That is, the outputs of each of the channels can be separately provided to a corresponding transducer, and each transducer may then provide a vibration based on the UAR speech in the channel connected to that transducer. The outputs of the plurality of transducers are received by the inner ear and transferred as signals to the brain (by way of nerve VIII), where they are perceived as speech. Alternatively, the outputs of the channels can be combined, or mixed, and then processed (by a transformer/attenuator network), to be provided to a single transducer. That single transducer produces a vibration based on the signals from all of the channels, which is passed into the inner ear, which in turn provides a signal to the auditory cortex of the brain (via nerve VIII), where it is perceived as speech.

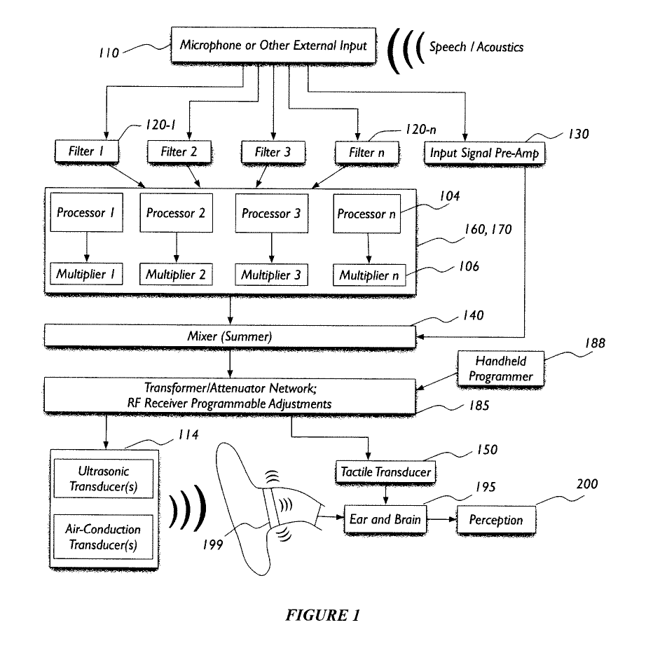

FIG. 1 shows a UAR hearing aid according to a second embodiment of the invention, in which a microphone 110 receives speech or some other signal such as music. The output of the microphone 110 is provided to a plurality of filters 120-1, 120-2, . . . , 120-n. The output of the microphone 110 is also provided to an input speech or tonal preamplifier 130, which does not filter the signal, as is done in the other channels 120-1, 120-2, . . . , 120-n. Although filtration may optional be performed on the input signal to provide sound conditioning. The preamplifier 130 provides speech directly to an optional mixer 140 and/or to a transformer/attenuator network 185. Both an UAR signal and the original signal are provided to the inner ear of the user.

Each channel 120-1, 120-2, . . . , 120-n has a filter that has a passband and center frequency at a different portion of the audio (or audible) frequency range. That way, certain portions of the audible speech range can be either emphasized or attenuated, as desired. The outputs of each channel are provided to an envelope extractor 160, which includes a plurality of extractors provided on a one-to-one basis for the plurality channels. Each envelope extractor is operable to extract the envelope of the output of the corresponding channel. Envelope extractors are readily available, and a discussion of such elements is not provided herein. For example, an RC filter having an appropriate time constant may be used to extract the envelope of a filtered speech signal.

The extracted envelopes are then provided to a multi-channel frequency multiplication network 170, where each extracted envelope is separately modulated and frequency converted to a UAR frequency. As discussed above, various types of modulation techniques, such as am, fm, double-sideband modulation, full am, single-sideband modulation, or the like, may be utilized. The modulated signals also may be amplified, as required, in the multiplication network 170. The output of the multiplication network 170 is shown as being provided to the optional mixer 140. In the second embodiment shown in FIG. 1, the mixer 140 mixes or combines each of the UAR signals, as well as the unmodulated signal received from preamplifier 130. The output of the mixer 140 is provided to a transformer/attenuator array 185, where the unmodulated signal is amplified, attenuated, or processed based on commands received over-the-air by a radio frequency receiver (not shown) in the transformer/attenuator array 185. Those commands are output by way of a hand-held programmer 188. If a mixer is not provided, then the separate UAR signals and the non-UAR signal (output from preamplifier 130) are separately provided to the transformer/attenuator array 185, which is configured to separately process each of the received signals based on commands received by way of the hand-held programmer 188.

The transducer unit 150 provides vibrations based on the input signals to that unit. Preferably, the transducer unit 150 is made up of one or more piezoelectric devices. If a mixer is used, the transducer unit 150 corresponds to a single transducer. If a mixer is not used, then the outputs of the transformer/attenuator array 185 are separately provided to a bank of transducers within the transducer unit 150. The vibrations caused by the transducer/transducers are received in the inner ear 195, where they are processed and provided to the brain 195 and interpreted as intelligible speech. The transducer unit 150 may be phase or otherwise manipulated to result in an acceptable sound image for the listener. As shown in the bottom part of FIG. 1, the transducer unit 150 may be disposed on the head or neck of the user, or it may be disposed, as shown by transducer unit 199, in the ear canal, where it is in contact with the walls of the ear canal. Transducer unit 199 produces vibrations of the canal wall, as well as sound in the canal. Transducer unit 199 can alternatively be used together with transducer unit 150 in another possible implementation.

Although certain embodiments of the invention have some things in common with the supersonic, bone conduction hearing aid disclosed in U.S. Pat. No. 4,982,434, which is incorporated in its entirety herein by reference, there are important differences. The UAR hearing aid according to the invention differs from the supersonic hearing aid in that, for certain embodiments of the invention, both air and bone conducted signals are provided to the ear. Also, for certain embodiments of the invention, the UAR hearing aid is a multi-channel instrument that allows the brain to combine correlated waveforms, which have been extracted from the same speech signal, into precepts of the original speech band, by relying on the amplitude time information and not the spectrum to accomplish this task. Also, the supersonic hearing does not use the low ultrasonic frequency range (<30 kHz), as in the embodiments of the invention. Furthermore, in the embodiments that use the audio speech signal along with the UAR signals, the supersonic hearing aid does not incorporate such an audio signal to be provided with other signals in speech perception. The present invention also differs from other speech envelope extracting systems in that the present invention is high frequency and low ultrasonic (10-30 kHz) and that no speech waveform rectifier is necessary in that biorectification is present.

The present invention, when used for speech recognition, allows for preferentially amplifying envelope aspects of the full speech signal to enhance perception as high frequency consonants. These sound units are often overshadowed by vowel energy in the single channel hearing aids and, as a result, intelligibility of speech is lowered. The embodiments of the invention also are designed to serve as an augmentation to normal communications systems in high noise areas. The speech envelope cues used in the embodiments of the invention are resistant to audio noise masking, and helps reduce ambiguity in audio speech.

### EXEMPLARY AND PREFERRED EMBODIMENTS

### Example 1

### Ultrasonic Assisted Music Perception

In one or more embodiments of the present invention, a user is allowed to select a frequency range wherein the user's auditory function is diminished. For example, a user may select the frequency ranges which correlate predominantly with non-vocal and non-speech sounds. It is commonly understood that speech signals are generally in the frequency range of about 500 to about 8200 Hertz, wherein the range from about 2000 to about 8200 Hertz comprises labial and fricative sounds, which give presence to speech. The device may modulate signals within the “speech range” of frequencies because signals corresponding to non-vocalizations may be present in this range. The algorithms and processing are adapted for non-speech signals and need not be constrained to any particular frequency range. A novel and inventive feature of the present invention is the modulation of processed music or other non-vocal patterns on an ultrasonic carrier. The carrier wave comprising such patterns is demodulated by the natural resonance of the brain and other anatomical structures and results in the perception of a high frequency sound, thus restoring a degree of high-pitch perception not available from conventional airborne hearing.

In embodiments of the invention designed specifically for enhancing music or tonal perception, the invention comprises at least one and preferably all of the following elements:
At least one input that receives a signal comprising a signal for modification. Such an input can receive live or recorded signals such as music or non-vocal patterns. Such an input can also be a transducer such as a microphone. These signals may be fed to a plurality of channels;
At least one variable channel filters designed to select a passband in the music spectrum for ultrasonic processing. The slope of the filter is also selectable from narrow to wide. Each filter is independent and different passbands can be selected;
At least one channel multiplier. Each selected passband will be multiplied by a high or ultrasonic frequency carrier (10-100 kHz). Different carriers may be selected for each channel;
At least one channel amplifier 108, with variable gain, to provide the necessary loudness to compensate for hearing sensitivity;
At least one sound conditioner 110. This element provides additional processing algorithms (e.g., filtering, spectral analysis, frequency tracking) to convey significant features of the signal (e.g., envelope, fundamental frequency, harmonic structure, attack/decay) to the listener;
At least one high frequency mixer 112. This element allows the operator to sum all the channels into a single signal; and
At least one transducer 114 designed to provide high frequency (10-100 kHz) stimulation to the head by bone conduction. This is to be used in conjunction with high fidelity air conduction stereo earphones in a preferred embodiment. Additional channels may be devoted to air conduction hearing.

In one embodiment of the present invention, a music signal or sample of a music signal is passed through at least one filter, and the signal is adjusted according to the operator's preference and hearing loss. The signals are then amplitude modulated and/or multiplied by an ultrasonic carrier. All types of modulation are possible but upper single sideband modulation is preferred. Spectral processing may occur utilizing a digital readout such that frequency and/or time characteristics of the signal may be monitored and modified. Finally, the resulting signal is provided to high-fidelity bone conduction transducers for listening. In a highly preferred embodiment, the resulting signal is presented using multimodal presentation as described above. For example, incorporation of a vibrating transducer can provide perception of frequencies up to around 800 Hz.

The invention therefore, in one or more embodiments, provides that each channel renews high pitch perception by modulating the selected signal with high frequency carriers. Each carrier frequency can be selected to accord with the user's particular hearing loss. Additional processing can be applied to the selected signal before mixing. Since all channels are derived from the same initial signal, e.g. the same music selection, the brain readily perceives the mixed signal as coherent, i.e. as a single signal. Again, the final signal is delivered to the head by high fidelity bone conduction transducers. At this point, the brain accomplishes physical demodulation with its resonance at about 10 kHz, thereby providing a return to the user of high frequency perception. In contrast, normal hearing aids, which pass high pitch sounds through the ear canal, are ineffective since they do not account for the natural filtering of the signal by the user themselves.

### Example 2

### Noise Reduction in Speech

Speech can be manipulated in a number of ways and surprisingly its intelligibility remains intact despite manipulation. These embodiments of the invention will “pre-process” speech by algorithms that will favor the type of neural mechanisms in the brain evolved to decode amplitude modulated (“AM”) signals.

In one preferred embodiment of the present invention, a speech, message, or other sound source such as the input from a microphone, that of an electronically prerecorded signal such as, but not limited to, a compact disc or MP3 player, or any other auditory signal is relayed to, after processing, to a transducer array. This is shown diagrammatically in FIG. 1 in which the source 110 is eventually relayed to a transducer array 114 and other transducers 150.

Before the signal is relayed to the transducer array, it is processed. For example, a first filtering system may be used to preprocess the speech signal in order to optimize the signal for relaying to the transducer. Such filtering can encompass any standard speech or signal filtering including bandpass filtering, amplitude and frequency modulation, noise reduction, or any other filtering technique commonly known to those skilled in the art of speech and/or signal processing.

The filtered signal(s) may eventually be relayed to a modulator that can incorporate multiple filtered (or otherwise processed) speech signals and a plurality of carriers. Said carriers will have frequencies in the audio frequency range and upwards to 100 kilohertz (kHz). To this end, the filtered signal(s) is first relayed through a temporal processor 104 and then to the modulator (multiplier) 106. The signals are then summed by a summer 108 (which can be further adapted to selectively sum signals), optionally amplified 110 (singly or through multiple amplifiers and their distributors 112) and relayed to at least one transducer distributed on the skin of the head or neck.

In one embodiment of the present invention, the invention spectrally shifts speech above ambient noise, first by amplitude modulation, and then by stimulation of neural structures in the ear. The brain and the structures therein function to demodulate the signal via a high frequency resonant system. Transmission of the signal to the inner ear in a manner adapted to provide simulation or modulation of sensitive neurons in the brain permits the inherent functionality of the brain to operate to demodulate the signal.

In a practical embodiment of the invention, live speech or other vocalizations are transformed into electronic signals by a microphone or microphone array or similar transducers such as accelerometers or other actuators. The resulting electronic signal is fed into a series of filters that optimize various speech sound characteristics. Additional algorithms may be used to refine the filtered spectrum, thereby enhancing the signals frequency and time parameters. The outputs are then fed into a modulating circuit. The modulating or multiplication circuit is a series of algorithms that transform the signal into a product signal. This product may be full AM, double sideband modulated (carrier suppressed), single sideband modulated (upper or lower with carrier) or single sideband modulated. There may be a plurality of carriers and hence a plurality of multiplication circuits. The output of these multiplications may be summed, in whole or in part, or even presented separately to a transducer or array of transducers for optimal comprehension.

The present invention in another embodiment is directed towards a method for allowing speech which cannot be readily understood in a high noise environment because of masking by overlapping, random frequencies, to be understood. The presence of randomly and intensely firing auditory neurons within the brain that fire, in part, because of auditory noise in the environment, results in the perception of noise, which masks, swamps, and/or prevents neural coding of speech sounds. Fortunately, speech can be distorted in many ways and still retain intelligibility, except in high intensity noise. This invention seeks to extract the potentially intelligible characteristics of speech, by filtering and temporal processing, shifting the intelligible characteristics of speech above the background noise by modulation (multiplication) and thenceforth combining different elements of the resulting modulated speech characteristics using algorithms to allow intelligibility upon physical demodulation by the brain. The exact mechanism or underlying theory behind brain demodulation is not entirely understood but an exact understanding is not necessary since the brain nonetheless functions to process inputted speech or sound signals in a manner consistent with this invention. One theory of the mechanism of brain demodulation suggests that speech is demodulated by shifting the signal to the upper most frequency register in the chochlea, allowing the signal to be coded by the nerve in spite of noise since the speech is not separated spatially in the neuroaxis. The speech retains a high pitch quality but is still intelligible. The brain may also use phase locking for low frequency coding of speech and other sounds. The temporal signature of speech has been used in algorithms to separate it from noise. In this invention, in a preferred embodiment, low frequency periodicity is used to add intelligibility to speech. The inventor has demonstrated that phase locking can occur (up to 800 Hz) when multiplied by an ultrasonic carrier. Such processing is an element in one embodiment of the current invention. The present invention may comprise any combination of the above elements provided the processing of the speech signal affects modulation such that the brain can demodulate a speech signal in spite of a high noise environment.

A signal may comprise a multitude of signals such that any reference to a signal is to be construed as encompassing a single signal or a number of signals. For example, a signal may refer to the output provided from a device A in which the output comprises signals 1, 2, and 3, as by signals provided on separate channels, carriers, or otherwise distinguishable means. A reference to the outputs of device A may be denoted by a reference to the signal of device A and not just the signals of device A.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention. It is further known that other modifications may be made to the present invention, without departing the scope of the invention, as noted in the appended claims.

I claim:

1. A device for improving the comprehensibility of speech in high noise environments, comprising:
a) a first component adapted to receive a signal or signals;
b) a second component adapted to filter said signal or signals non-temporally and optionally temporally;
c) a third optional component adapted to take any non-temporally filtered signal or signals and temporally filter said non-temporally filtered signal or signals;
d) a fourth component adapted to multiply said signal or signals with a carrier wave;
e) a fifth component adapted to selectively sum any signals;
f) a sixth and optionally seventh component adapted to amplify said signal or signals; and
g) a final component adapted to relay said signal or signals to a user via at least one or more of the following: an ultrasonic transducer, an air-conduction transducer, and a tactile/vibratory transducer.

2. The device of claim 1 wherein said first component provides said signal or signals to said second component; said second component provides said signal or signals to said third optional or said fourth component; wherein said third optional component provides said signal or signal to said fourth component; wherein said fourth component provides said signal or signals to said fifth component; wherein said fifth component provides said signal or signals to said sixth and optionally seventh components; wherein said sixth and optionally seventh component provide said signal or signals to said final component, and wherein said signal or signals are processed in a manner adapted to provide a final transduction signal comprising speech or vocalizations which are intelligible in high noise environments upon demodulation by said human brain.

3. A method of increasing the intelligibility of speech in high noise environments comprising using the device of claim 1 to process sound to provide an intelligible signal upon demodulation by said human brain and in which said device utilizes at least two modalities of perception.

4. A method of increasing the intelligibility of speech in high noise environments comprising the steps of:
a) receiving signals onto one or more channels;
b) filtering at least one of said signals on said channels non-temporally;
c) filtering at least one of said signals on said channels temporally;
d) modulating at least one of said signals on said channels onto an ultrasonic carrier wave;
e) optionally amplifying at least one of said signals on said channels;
f) optionally summing the channels to produce fewer channels contained summed signals; and
g) relaying the signals on all channels to the human brain by transduction using at least two modalities of perception.

5. A device for assisting in the perception of non-vocal patterns by a user comprising:
a component adapted to
receive an acoustic signal comprising non-vocal patterns,
producing a first signal or signals; and
in which said signal or signals are carried on at least one signal channel;
at least one variable channel filter which
receives said first signal or signals and is adapted to
select a passband for non-vocal signals,
producing a second signal or signals;
at least one channel multiplier adapted to
receive said second signal or signals and
multiply said second signal or signals by at least one high or ultrasonic frequency carrier, and
optionally amplifying said signal or signals;
producing a third signal or signals;
at least one sound conditioner adapted to
receive said third signal or signals and
provide a processing algorithm or algorithms adapted to convey the features of non-vocal patterns to said user,
producing a fourth signal or signals;
at least one high frequency mixer adapted to
receive said fourth signal or signals and to
sum the signals of the fourth signal or signals if more than one signal exists,
producing a single fifth signal; or relaying the fourth signal; and
at least one transducer adapted to
receive said fourth signal or fifth single signal and
provide high-frequency stimulation to the head according to said fifth single signal.

6. The device of claim 5 wherein said high frequency stimulation is by bone conduction on the user's head.

7. The device of claim 5 in which said device provides at least two modalities of perception by using a plurality of transducers.

8. The device of claim 5 wherein said high frequency stimulation is by vibratory conduction.

9. The device of claim 5, further comprising air-conduction earphones for use in conjunction with the device.

10. The device of claim 5 in which the slope of the variable channel filter is selectable from narrow to wide.

11. The device of claim 5 in which each variable channel filter is independent and different passbands can be selected.

12. The device of claim 5 in which the high or ultrasonic frequency carrier is from 10 to 100 kilohertz (kHz).

13. The device of claim 5 in which the sound conditioner uses filtering, spectral analysis, and/or frequency tracking.

14. The device of claim 5 in which the sound conditioner conveys the envelope, fundamental frequency, harmonic structure, attack, and/or delay of the non-vocal pattern.

15. A method for assisting in the perception of non-vocal patterns by a user comprising the steps of
receiving an acoustic signal comprising non-vocal patterns;
selecting a passband for non-vocal signals and filtering out signals outside the passband;
multiplying the passband selected signals with at least one high or ultrasonic frequency carrier;
amplifying the resulting signals;
conditioning the resulting signals and processing the resulting signals to convey the features of non-vocal patterns; and
mixing the signals to produce a single signal and relaying the signal to a user.
